(19) United States
(12) Patent Application Publication
(10) Pub. No.: US 2008/0106133 A1
(43) Pub. Date: May 8, 2008

(54) SEATING UNIT FOR SUPPORTING A BODY OR PART OF A BODY

(75) Inventors: Niels Vrijlandt, Delft (NL); Justus Laurens Herder, Rotterdam (NL)

Correspondence Address: HOFFMANN & BARON, LLP, 6900 JERICHO TURNPIKE, SYOSSET, NY, 11791, US

(73) Assignee: GEROME B.V., Rotterdam (NL)

(21) Appl. No.: 11/877,034

(22) Filed: Oct. 23, 2007

Related U.S. Application Data
(63) Continuation-in-part of application No. 10/479,391, filed on May 27, 2004, now abandoned.

(30) Foreign Application Priority Data
May 30, 2001 (NL) NL 1018178

(51) Int. Cl. B60N 2/02

(52) U.S. Cl. 297/302.1

(57) ABSTRACT

A seating unit for supporting a body or part of a body comprises a base part and at least one supporting part for supporting the body or part of the body. The supporting part is situated or can be placed in a set nominal height position relative to the base part. In addition, the supporting part is movable at least in the vertical direction over a certain movement range relative to the nominal height position, in such a way that within this movement range the supporting part can take up various positions of equilibrium when there is a certain weight on the supporting part. The supporting part is preferably supported by a balancing mechanism, in particular a spring compensation mechanism.

### CROSS-REFERENCE TO RELATED APPLICATIONS

This application is a continuation-in-part of application Ser. No. 10/479,391, filed May 27, 2004, which is the National Stage under 35 U.S.C. §371 of International Application No. PCT/NL02/00344, filed May 29, 2002, which claims the benefit of Netherlands Application No. NL 1018178 filed May 30, 2001, the contents of which are incorporated herein by reference.

### FIELD OF THE INVENTION

The invention relates to a seating unit for supporting a body or part of a body, comprising a base part and at least one supporting part for supporting the body or part of the body, the supporting part being situated or being capable of being placed by adjustment facilities in a set nominal height position relative to the base part.

### BACKGROUND OF THE INVENTION

Such a seating unit is known, for example in the form of an office chair. Known office chairs are available in various embodiments and often have several adjustment facilities. The seat is adjustable in height and to various angular positions. The backrest and the armrests are also usually adjustable to various positions. The object of these adjustment facilities is to prevent physical and psychosomatic complaints that result from sitting for long periods, for example when working in front of a VDU.

### OBJECTS OF THE INVENTION

The object of the present invention is to provide an improved seating unit of the type mentioned in the preamble, in which the abovementioned physical and psychosomatic complaints are prevented even more effectively.

### SUMMARY OF THE INVENTION

This object is achieved according to the invention by the fact that the supporting part is movable at least in the vertical direction over a certain movement range relative to the nominal height position, in such a way that within this movement range the supporting part can stay in various positions of equilibrium when there is still the same load on the supporting part.

The invention is based on the insight that a dynamic body support ensures more movement while a person is sitting on a chair, which very probably acts preventively against physical and psychosomatic complaints. These movements must be easy to carry out, without all kinds of adjustments having to be carried out on the chair. On the other hand, these movements must take place within a limited range, since otherwise sitting on the chair gives a feeling of instability.

Preferred embodiments of the seating unit according to the invention are set out in the subclaims.

### BRIEF DESCRIPTION OF THE DRAWINGS

The invention will be explained in greater detail in the description below of a number of preferred embodiments of the seating unit according to the invention in the form of a chair, in particular an office chair, with reference to the drawing, in which:

FIG. 1 is a side view of an office chair according to the invention;

FIG. 2 shows a part of the office chair of FIG. 1 on an enlarged scale;

FIG. 3 shows diagrammatically a spring compensation mechanism used in the case of the office chair of FIG. 1;

FIGS. 4a and 4b show the basic principle of the spring compensation mechanism in two embodiments;

FIG. 5 shows diagrammatically the movement range of the seat of the office chair of FIG. 1;

FIG. 6 shows a part of an office chair with a different embodiment of the spring compensation mechanism;

FIG. 7 shows diagrammatically the spring compensation mechanism in the case of an office chair in which a bridge piece of the seat is movable in the vertical direction relative to a rod mechanism;

FIG. 8 shows a side view of an office chair in a best mode embodiment having an undercarriage according to the invention;

FIG. 9 shows a top view of the undercarriage as shown in FIG. 8; and

FIG. 10 shows an enlarged view of a worked open part of the office chair from FIG. 8.

### DETAILED DESCRIPTION OF THE INVENTION

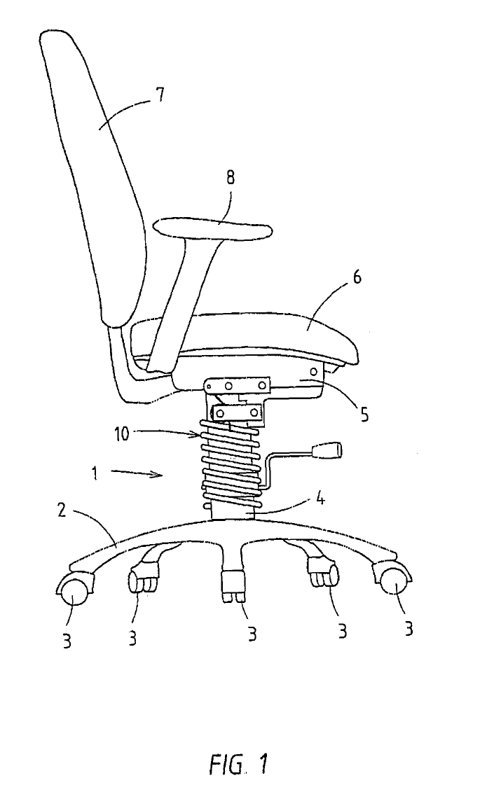

An office chair according to the invention is shown in FIG. 1. The office chair is essentially designed as a conventional office chair with a pedestal 1, consisting of a star base 2, which is provided with castors 3, and a gas lift 4 or another height-adjustable central column fitted on the star base. A supporting part for a part of the body is fitted on the gas lift 4, said supporting part being in the form of a seat 6 fitted on a bridge piece 5. The chair is further provided with a backrest 7 and armrests 8. Such an office chair, which is generally known as regards the abovementioned parts, usually has several adjustment facilities. The height of the seat 6 is adjustable by means of the gas lift 4. The seat 6 can be tilted by means of the bridge piece 5. Furthermore, the backrest 7 and the armrests 8 are adjustable into various positions. The various adjustment facilities serve to place the respective parts of a chair in the optimum position for the user.

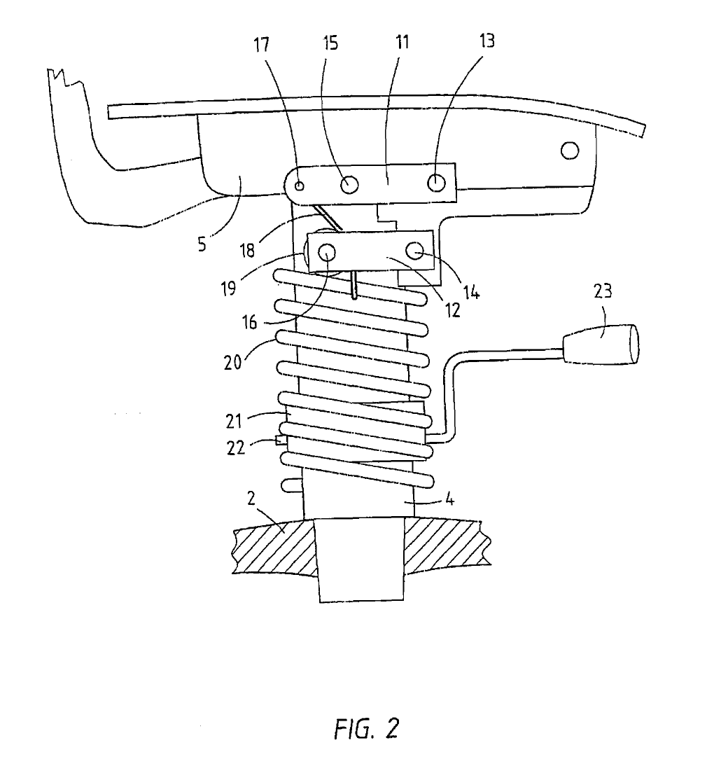

The office chair according to the invention has yet a further facility, the purpose of which is to make the user of the chair move more while sitting, for example while working in front of a VDU, in order to prevent physical and psychosomatic complaints as a result of sitting for long periods. This facility is composed of a balancing mechanism fitted between the gas spring 4 and the bridge piece 5 of the seat 6, in the form of a spring compensation mechanism 10, which is shown in greater detail in FIG. 2. This spring compensation mechanism 10 is designed in such a way that the seat is movable over a certain movement range at least in the vertical direction relative to the nominal height position, which is determined by the height adjustment by means of the gas lift 4, in such a way that within said movement range at substantially the same vertical load (part of the weight of the chair and of the user who is sitting on the chair) the seat can remain in various positions of equilibrium. Which means that there is an equilibrium between the vertical load and a constant force generated by the spring compensation mechanism 10. The constant force compensates the vertical load.

The spring compensation mechanism 10 comprises at least one rod mechanism, consisting of two parallel rods 11 and 12 placed one above the other, which rods at one end are pivotally connected to the bridge piece 5 by means of pivots 13 and 14, and at the other end are pivotally connected to the gas lift 4 by means of pivots 15 and 16. The pivots 15 and 16 may, if desired, be fitted on an intermediate part (not shown here) fitted on the gas lift 4. The bridge piece 5 and the seat fitted on it are consequently movable in height, parallel to themselves, relative to the gas lift 4. Owing to the construction of the rod mechanism, during a movement in the vertical direction the bridge piece 5 and the seat 6 will also carry out a slight movement in the horizontal direction.

The top rod 11 is extended on the side of the pivot point 15 that is situated opposite the pivot point 13. A cable 18 is attached to the rod 11 near the end 17 of the extended part. Said cable 18 runs downwards over a pulley 19 that is concentric with the pivot point 16, and is fixed to a spring 20, which is fitted around the gas lift 4. The spring 20, in the form of a coil spring, pulls the end 17 of the rod 11 downwards by means of the cable 18.

The spring constant of the spring 20 is adjustable by means of a nut 21, which is fitted inside the spring 20. The nut 21 is fitted on a threaded rod, the pitch of the screw thread corresponding substantially to the pitch of the spring 20 in the released position. Pins 22 that engage between the coils of the spring 20 are fitted on the outside of the nut 21. The nut 21 can be screwed up and down by means of a control knob 23.

In order to achieve the desired effect of the invention, the spring constant of the spring 20 must be adapted to the weight of the user of the chair, in such a way that when the user is sitting on the chair and moves slightly, the seat 6 automatically moves with the user, without a significant force being necessary to achieve this. The user sitting on the chair experiences a “floating” sensation during this movement.

The principle of a balancing mechanism in the form of a spring compensation mechanism is known, and is described in, inter alia, EP 0007680 and NL 1009886, the contents of which are referred to here. However, balancing mechanisms such as those described in the abovementioned publications have never been used in the case of a chair in order to give the user sitting on the chair the sensation of “floating”.

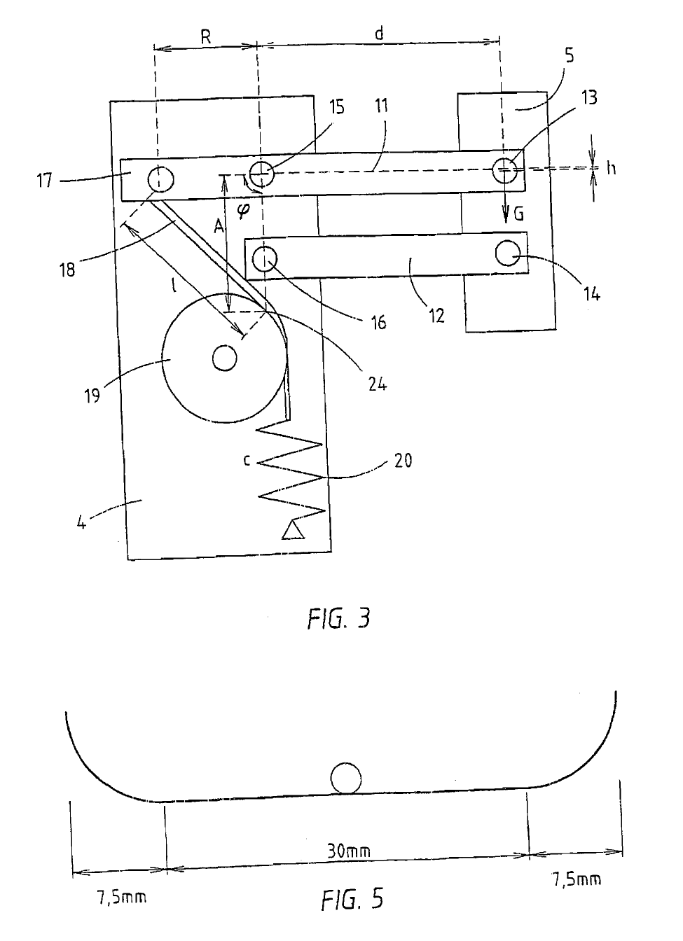

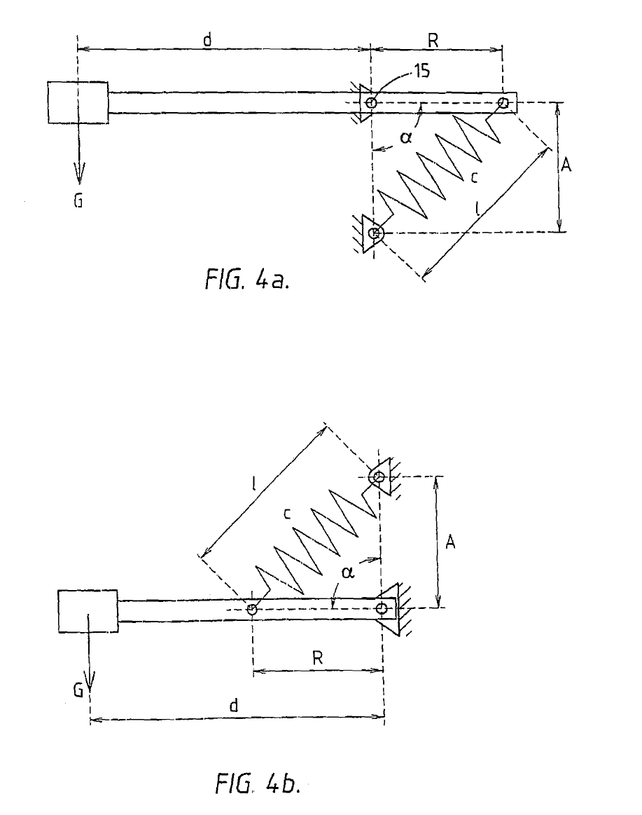

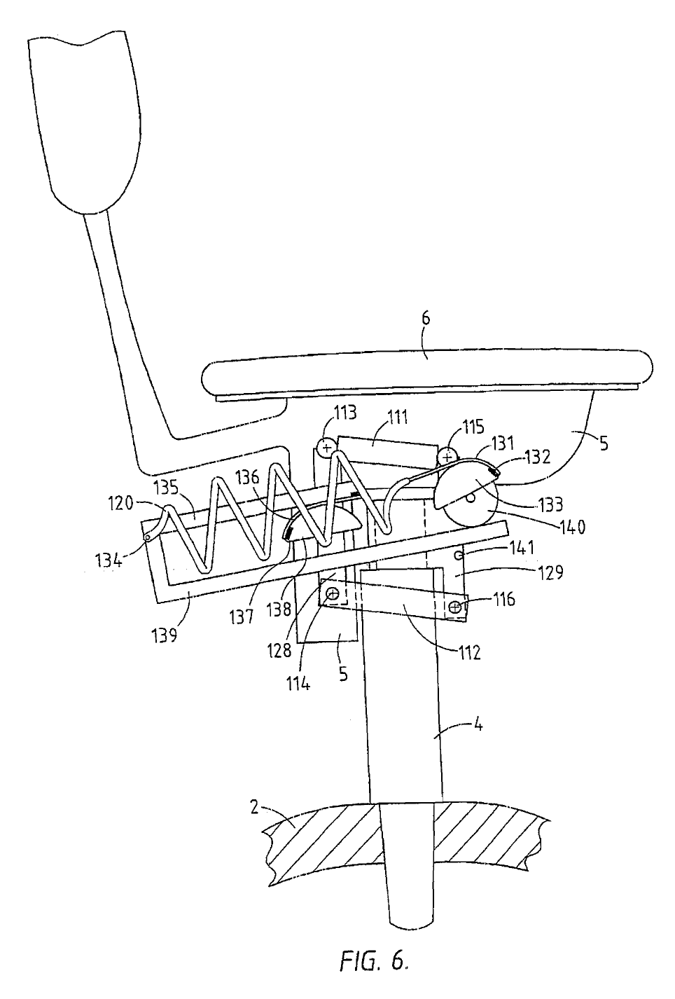

The principle and the functioning of the spring compensation mechanism used in the case of the office chair described above will be explained in greater detail with reference to FIG. 3, in which said mechanism is shown diagrammatically. Reference is also made to FIGS. 4a and 4b, in which the basic principle of a spring compensation mechanism is shown in two exemplary embodiments.

The various distances R, d, l and A are indicated in FIG. 3 and FIGS. 4a and 4b. The load G is caused by a part of the weight of the chair and of the user sitting on the chair. The height of the action point of the load G on the rod 11 relative to the point of rotation 15 of the rod 11 is indicated by h.

The distance between the connection point of the cable 18 with the end 17 of the rod 11 and the point of contact 24 of the cable 18 with the pulley 19 is l. The point of contact 24 lies substantially directly below the point of rotation 15 of the rod 11. The distance l corresponds to the extension of the spring 20 from the released position. The spring constant of the spring 20 is c.

The angle φ is the angle between the rod 11 and the line between the point of rotation 15 and the point of contact 24.

When the height position of the supporting part with a particular load thereon changes, the potential energy of the load also changes. This change in potential energy of the load is compensated by a change in potential energy of the balancing mechanism, for example the reduction of the potential energy of the load is compensated with an increase of the potential energy of a spring in the balancing mechanism. As a result, the total potential energy of the spring compensation mechanism remains constant for various height positions of the load, without the use of external energy such as adjustment facilities.

According to the invention in order to compensate for the load G at every angle φ of the rod 11, the potential energy Eₚₒₜ of the spring compensation mechanism must remain constant.
Eₚₒₜ=E_{grav}+Eₑₗₐₛ
In this formula:

$$\begin{matrix}{E}_{grav} = the potential energy of the load G \\ = G . h = G . d . cos φ \\ {E}_{elas} = potential energy of the spring 20 \\ = \frac{1}{2} . c {.1}^{2} ( surface area below the spring characteristic ) \\ = \frac{1}{2} . c ( {A}^{2} + {R}^{2} - 2 A . R . cos φ ) \\ = \frac{1}{2} . c ( {A}^{2} + {R}^{2} - c . A . R . cos φ )\end{matrix}$$

If Eₚₒₜ must be constant for each angle φ, the following must apply:
G.d=c.A.R

Since d, A and R are constant, as in the case of the spring compensation mechanism of FIG. 3, for a compensation of the load G at each angle φ the spring constant c must therefore be proportional to the load G.

In the case of the chair according to the invention the magnitude of the range within which various positions of equilibrium can be taken up when the same vertical load is applied to the seat, the so-called “floating range”, is fixed at approximately 30 mm. A shorter range has the result that the user sitting on the chair moves too little. If the movement range is greater, an unstable feeling is produced, and the user who sits down on the chair first has to overcome a certain anxiety before the “floating movement” can be enjoyed.

In order to prevent the movement from coming to an abrupt end at the ends of the movement range, a range with a certain damping is provided at each of the two ends of the movement range. The length of these damping ranges is approximately 7.5 mm. This damping can be produced by means of rubber shock absorbers.

FIG. 5 shows diagrammatically the abovementioned ranges of the seat 6. The movement of the seat 6 can be compared to the movement of a ball in a channel of the shape indicated in FIG. 5.

In the case of the embodiment illustrated in FIGS. 1 and 2 the rods 11 and 12 are fitted in such a way that relative to the gas spring 4 they are directed towards the front side of the chair. However, it is also possible to fit the rods 11 and 12 in such a way that relative to the gas spring 4 they are directed towards the rear side of the chair.

The description discloses a rod mechanism composed of two rods 11 and 12 placed one above the other.

For design reasons, it may be desirable to make the rods 11 and 12 each in the form of double rods, the partial rods being fitted on either side of the gas lift 4.

Instead of a rod mechanism of the type described above, leaf springs could also be used, said leaf springs being provided with reinforcement pieces, in such a way that the parts provided with reinforcement pieces act as rods, and the parts not provided with reinforcement pieces act as pivots.

FIG. 6 shows a different embodiment of a spring compensation mechanism fitted between the gas spring 4 and the bridge piece 5 of the seat 6. In FIG. 6 parts of the spring compensation mechanism that correspond functionally to parts of the spring compensation mechanism shown in FIG. 2 are indicated by the same reference numerals, but provided with the prefix “1”.

The spring compensation mechanism shown in FIG. 6 comprises at least one rod mechanism composed of two parallel rods 111 and 112, which are placed one above the other and at one end are pivotally connected by means of pivots 113 and 114 to a first intermediate part 128 that is connected to the bridge piece 5, and at the other end are pivotally connected by means of pivots 115 and 116 to a second intermediate part 129 that is fitted on the gas lift 4.

The pivots 114 and 116 are in the form of, for example, ball bearings or roller bearings. The pivots 113 and 115 in FIG. 6 are in the form of rolling links, which have a very low friction. The pivots 113 and 115 could, however, also be in the form of ball bearings or roller bearings. At least some of the pivot points of the rod mechanism and of the connection of the spring are pivot points with a low friction. The friction in the spring compensation mechanism is such that in the main an additional force of a maximum of 25N, in particular a maximum of 10N, is needed to be able to set the supporting part in motion in the movement range.

The spring compensation mechanism further comprises a spring 120, which is active between the second intermediate part 129 mounted on the gas lift 4 and the bridge piece 5 of the seat 6.

The spring 120 is connected on the side of the gas lift 4 to one end of a flexible belt 131, which is fixed at the other end, at the position of a fixing point 132, on the outside of a part 133, which projects towards the side and is immovably connected to the second intermediate part 129, and which is at least partially circular cylindrical in shape. From the fixing point 132 onwards, the flexible belt 131 rests at least partially against the outside of the projecting part 133.

On the side of the bridge piece 5, the spring 120 is fixed, at the position of a fixing point 134, to one end of an arm 135. At the other end, the arm 135 is connected to one end of a flexible belt 136, which at the other end is fixed, at the position of a fixing point 137, on the outside of a part 138, which projects towards the side and is immovably connected to the bridge piece 5, and which is at least partially circular cylindrical in shape. From the fixing point 137 onwards, the flexible belt 136 rests at least partially against the outside of the projecting part 138.

As an alternative, instead of the flexible belts 131 and 136 and the partially circular cylindrical projecting parts 133 and 138, ball bearings or roller bearings could be used for connecting the spring 120 to the second intermediate part 129 and the bridge piece 5 respectively. Other pivoting connections are also conceivable.

Near the fixing point 134, an L-shaped supporting arm 139 is fixed on the end of the arm 135, the end part of which supporting arm rests against a roller element 140, which is fitted at the position of the projecting part 133 and preferably concentrically with the circular cylindrical external surface of said projecting part. Instead of the L-shape, the supporting arm 139 could also be of another shape. The supporting arm 139 could also be fixed on the arm 135 at another point, for example near the projecting part 138.

The construction described above is such that the arm 135 and the supporting arm 139 fixed on it always have the tendency to turn in an anticlockwise direction in FIG. 6, so that the supporting arm always rests against the roller element 140. As an additional locking facility, a stop 141 is further fitted on the second intermediate part 129, which stop prevents the arm 135, and the supporting arm connected to it, from being able to swing back in a clockwise direction.

The pulling force of the spring 120 ensures that the first and second intermediate part 128 and 129 are pulled towards each other. This means that if the pivots 113 and 115 are in the form of rolling links, the rod 111 will remain in place.

The spring compensation mechanism shown in FIG. 6 can be adapted to the weight on the seat by setting the spring constant of the spring 120, in a similar way to that of the spring compensation mechanism shown in FIGS. 1-3. The first intermediate part 128 in that case is immovably connected to the bridge piece 5 of the seat 6.

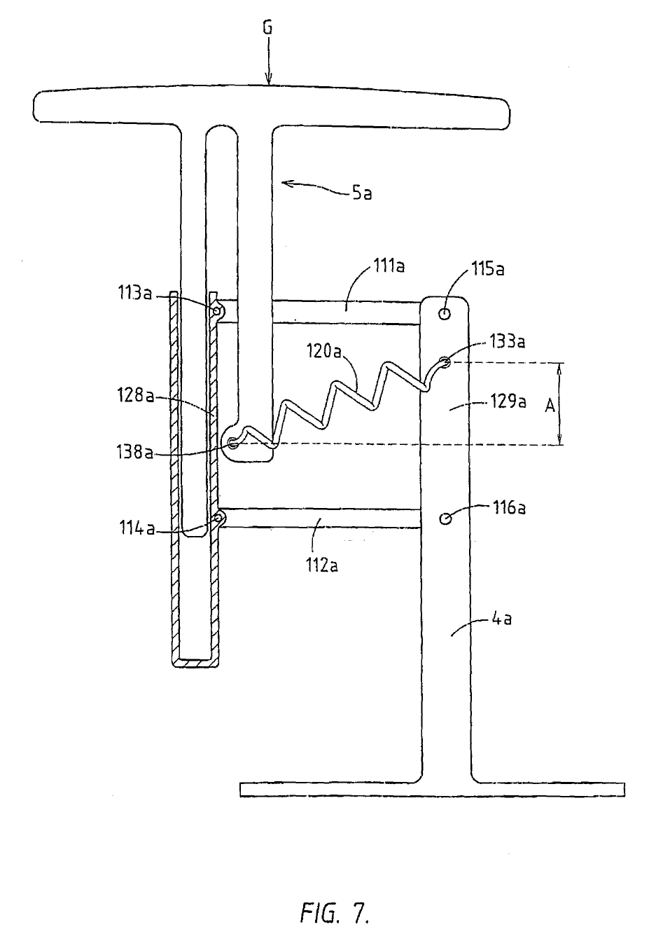

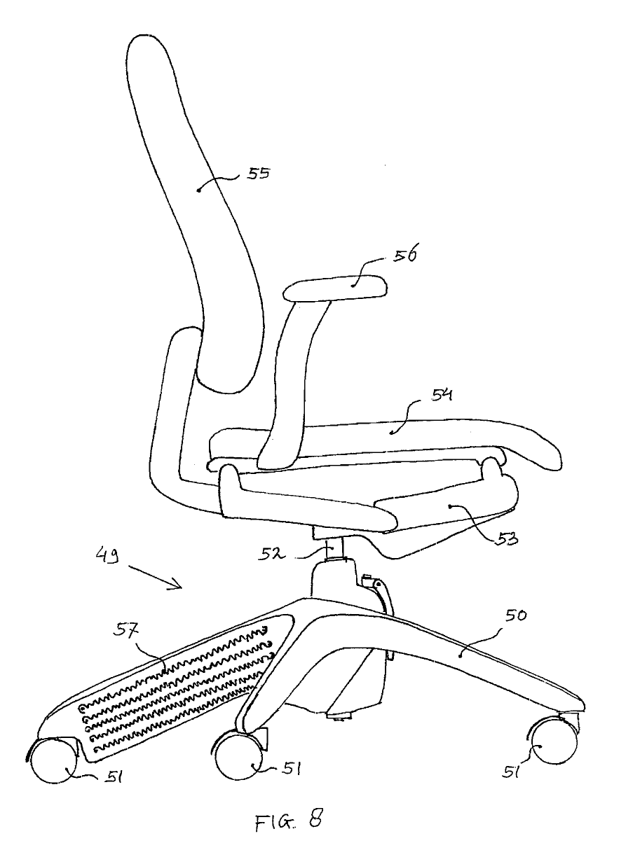

However, the spring compensation mechanism shown in FIG. 6 can also be set in another way. For that purpose, the bridge piece 5 of the seat is movable in the vertical direction relative to the first intermediate part 128. All this is shown diagrammatically in FIG. 7. In FIG. 7 parts that correspond functionally to parts of the spring compensation mechanism shown in FIG. 6 are indicated by the same reference numerals, but provided with the suffix “a”.

When the bridge piece 5a is loaded with load G, the bridge piece 5a will move downwards relative to the first intermediate part 128a until the counterforce exerted upon the bridge piece by the spring 120a is equal to the load G. In that situation the bridge piece 5a is fixed relative to the first intermediate part 128a. This setting, which can be regarded as a self-setting, amounts to the adjustment of the distance A to the load G in the abovementioned formula G.d=c.A.R (see also FIG. 3 and FIGS. 4a and 4b). The spring constant C, the distance d and the distance R can now remain constant.

The fixing of the bridge piece 5, 5a relative to the first intermediate part 128, 128a can be achieved by means of different locking mechanisms that are known to the person skilled in the art.

It is possible to use a different spring compensation mechanism or even a different type of balancing mechanism, instead of the spring compensation mechanism described above.

It is also conceivable for not only the seat 6 of a chair, but also armrests of a chair to be provided with a balancing mechanism by means of which a “floating effect” is achieved.

According to the idea underlying the invention, it is important for the user of a chair or the like, in particular an office chair, to begin moving as easily as possible. The fact is that the more easily the user begins moving the more often he will begin moving. However, in view of the friction that occurs in the spring compensation mechanism, it is not possible to set the seat in motion without some force.

The setting of the spring compensation mechanism (spring constant of the spring or the position of the bridge piece of the seat relative to the first intermediate part of the rod mechanism) could also be achieved electronically. The spring compensation mechanism can be adapted continuously (possibly with a certain time delay) to the weight of the user of the chair.

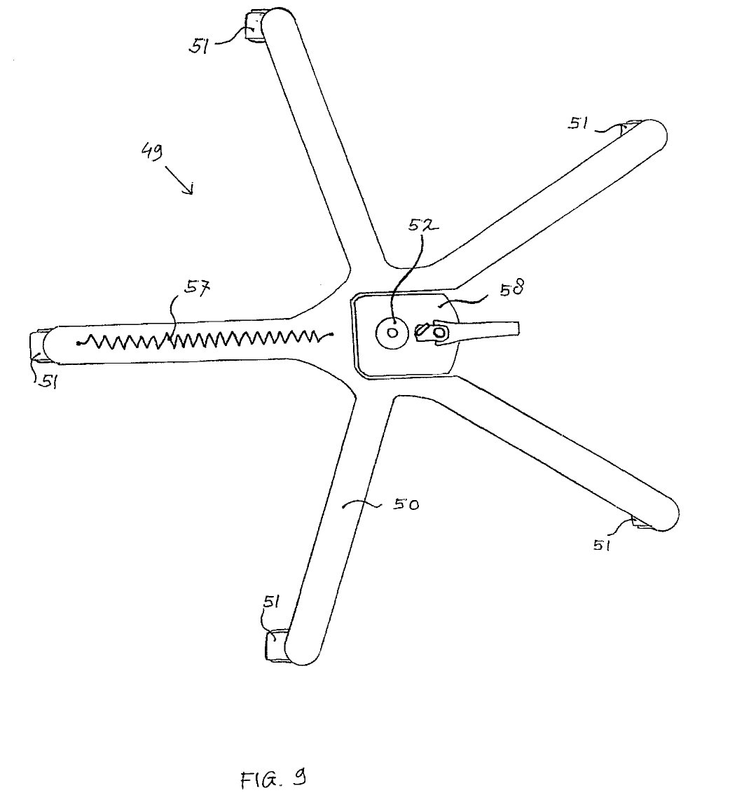

FIGS. 8, 9 and 10 show a third alternative mode of the seating unit which is regarded as the best mode according to the invention. Here, the spring compensation mechanism is fitted in the undercarriage 49 of the seating unit.

FIG. 8 is a side view of an office chair according to the invention. The office chair corresponds in several aspects with a regular office chair having a pedestal or a so called undercarriage 49 comprising a star base or a so called foot cross 50 with ends provided with wheels 51, e.g. castors. An upper carriage is fitted on a gas lift 52, comprising a bridge piece 53, a seat 54, a back support 55 and arm rests 56.

The spring compensation mechanism operates between the foot cross 50 and the gas lift 52, wherein spring elements 57 are located in one of the five ends of the foot cross 50. This arrangement brings the advantage that the spring elements 57 do not take up much extra space. Another advantage is that, if the bridge piece 53 is disconnected from the gas lift 52, any other upper carriage can be easily fitted, such as an upper carriage of a different office chair or a relaxing chair.

In FIG. 8 one end of the foot cross 50, a so called toe, is illustrated as semi-transparent to disclose the spring elements 57.

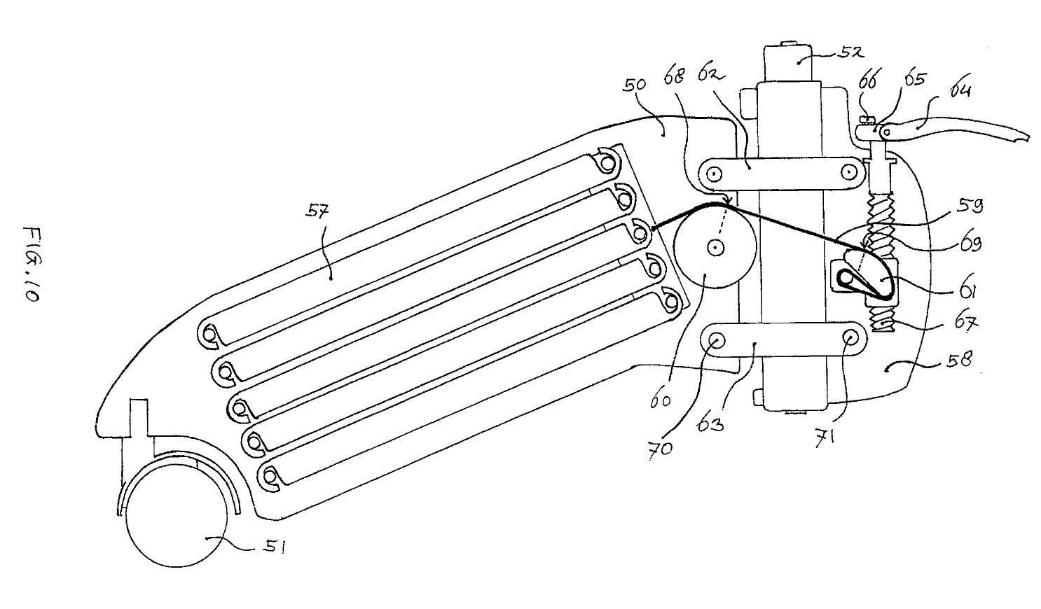

In FIG. 9, a plan view of the undercarriage 49 from FIG. 8 is shown, wherein the foot cross 50 and the gas lift 52 are indicated. A floating part 58 is connected to the gas lift 52 and both of these move in conjunction in relation to the foot cross 50. One of the five ends is illustrated as transparent to provide a view on the spring elements 57.

In FIG. 10 an enlarged view of a worked open part of the office chair from FIG. 8 is displayed, according to the invention. The spring compensation mechanism is fitted between the foot cross 50 and the floating part 58 connected to the gas lift 52 and contains at least one spring element 57 that is connected to one side to the foot cross 50, and on the other side to a flexible element 59 with a fixed length. This flexible element 59 first extends to a part of the outer perimeter of a hinged cylindrical element 60 on the foot cross 50 and is connected next to a carriage 61 on the floating part 58, causing the spring load of the spring elements 57 to supply a balancing momentum to a hinged parallelogram-shaped four rod system. The foot cross 50 and the floating part 58 of this four-rod system form two substantially vertical rods comprising the other two parallel hinged rods 62 and 63 there in-between.

The carriage 61 is movable in height to adjust the vertical position of the carriage 61 in relation to the floating part 58. In FIG. 10, a hinged lever 64 with a ratchet head 65 is shown. A switch 66 is mounted on the ratchet head 65, which allows the ratchet head 65 to rotate a spindle 67 clockwise or counter-clockwise, thus causing the carriage 61 to move up or down.

This movement adjusts the magnitude of the vertical constant force provided by the spring compensation mechanism to be able to balance different loads.

The magnitude of the vertical constant force is equal to the vertical distance between points of contact 68, 69 of the flexible element 59 with the outer perimeter of the cylindrical element 60 and the carriage 61, multiplied by the spring constant of the spring elements 57, if the rods 62, 63 are positioned horizontally.

The horizontal distance between the points of contact 68, 69 is, in this horizontal position of the rods 62, 63, equal to the distance between the hinge points 70, 71 of rod 63.

To ensure the vertical force remains constant, the distance between the points of contact 68, 69 must be equal to the extension of the spring elements 57 from a relaxed state, during all of the movements of the carriage 61 in relation to the foot cross 50.

Therefore, the length of the flexible element 59 that rolls up over the outer perimeter of the hinged cylindrical element 60 on the foot cross 50 is equal to the flexible element 59 unrolling from the outer perimeter of the cylindrical part of the carriage 61. The flexible element 59 is preferably constructed as a thin band with little elasticity along its length, such as banded steel with a thickness of less than 0.2 millimetres.

To make sure that the user of the seating element reaches the end of the movement path less quickly, one can allow the constant force to not be entirely constant.

This can be achieved easily by extending the length of the flexible element 59 some millimetres beyond the prescribed length, for instance 4 millimetres.

The rods 62, 63 and the flexible element 59 can also be provided in pairs, such that they can be fitted at either side of the gas lift 52. The flexible element may comprise one or more continuous loops, providing multiple several elements running across each other.

An office chair according to the invention is described above. The invention is not limited to an office chair, but also extends to other seating elements, for example a simple chair or a stool.

What is claimed is:

1. Seating unit for supporting a body or part of a body, comprising a base part and at least one supporting part for supporting the body or part of the body, the supporting part being situated or being capable of being placed by adjustment facilities in a set nominal height position relative to the base part, the supporting part is supported by a balancing mechanism, which makes the supporting part, movable at least in the vertical direction over a certain movement range relative to the nominal height position, in such a way that within this movement range the supporting part can stay in various positions of equilibrium when there is still the same load on the supporting part.

2. Seating unit according to claim 1, in which during use the potential energy of the load together with the potential energy of the balancing mechanism remains constant in said various positions of equilibrium.

3. Seating unit according to claim 1, in which the supporting part can stay in said various positions of equilibrium, without a significant force being necessary to achieve this.

4. Seating unit according to claim 1, in which the balancing mechanism is a spring compensation mechanism.

5. Seating unit according to claim 4, in which the spring compensation mechanism comprises a rod mechanism, consisting of two parallel rods placed one above the other, which rods at one end are pivotally connected to the base part and at the other end are pivotally connected to the supporting part or to an intermediate part that is to be connected to the supporting part, the pivot points of the one rod being situated at the same distance from each other as the pivot points of the other rod, and also consisting of a spring acting between the base part and the rod mechanism or between the base part and the supporting part that is connected or is to be connected to the rod mechanism, the spring compensation mechanism being adjustable in such a way that, at a certain weight on the supporting part, the supporting part is always in equilibrium within the movement range.

6. Seating unit according to claim 5, in which the spring compensation mechanism is adjustable by adjusting a spring constant of the spring.

7. Seating unit according to claim 5, in which the spring compensation mechanism is adjustable by adjusting a position in the vertical direction of at least one of action points of the spring relative to the rod mechanism.

8. Seating unit according to claim 5, in which the spring is connected to the base part by means of a pivot connection and the spring is connected to the supporting part by means of a rigid arm, which rigid arm is connected to the appropriate end of the spring and at the other end is connected by means of a pivot connection to the supporting part, the arm facing away from the end of the spring being connected to the base part, and the arm being connected to a supporting arm whose end part rests against a support provided on the base part.

9. Seating unit according to claim 8, in which the spring is connected to the base part by means of a flexible belt, which is connected to the appropriate end of the spring and the free end part of which is passed over a circular cylindrical external surface of a projecting part immovably fixed to the base part and is connected to the latter at the end, and in which the spring is connected to the supporting part by means of a rigid arm connected to the appropriate end of the spring which, at the other end, is connected to a flexible belt, the free end part of which is passed over a circular cylindrical external surface of a projecting part that is immovably fixed to the supporting part and is connected to the latter at the end.

10. Seating unit according to claim 9, in which the spring is connected to the supporting part, the supporting part being movable in the vertical direction relative to the intermediate part of the rod mechanism to which the supporting part can be connected, and the spring compensation mechanism being adjustable by adjusting the position in the vertical direction of the supporting part relative to the intermediate part.

11. Seating unit according to claim 5, in which at least some of the pivot points of the rod mechanism and of the connection of the spring are pivot points with a low friction.

12. Seating unit according to claim 11, in which the friction in the spring compensation mechanism is such that an additional force of a maximum of 25N, in particular a maximum of 10N, is needed to set the supporting part in motion in the movement range.

13. Seating unit according to claim 1, in which the supporting part (6) comprises a seat of the seating unit.

14. Seating unit according to claim 13, in which the seating unit is an office chair, and the office chair has a pedestal with a star base and a vertically adjustable central column fitted on the star base, in particular a gas lift, a supporting part fitted on the central column, in the form of a seat fitted on a bridge piece, and in which the balancing mechanism is integral with the central column and the bridge piece.

15. Seating unit according to claim 1, in which the supporting part comprises armrests of the seating unit.

16. Seating unit according to claim 4, wherein the spring compensation mechanism is arranged in an undercarriage of the seating unit and wherein spring elements are provided in at least one end of a foot cross of the undercarriage.

17. Seating unit according to claim 4 further comprising an undercarriage and a vertically adjustable central column, wherein the spring compensation mechanism operates between the undercarriage and a floating part which is connected to the central column, wherein the spring compensation mechanism comprises at least one spring element which is connected on one side to the undercarriage and on the other side to a flexible element with a substantially constant length, and wherein the flexible element is adjacent to a part of the outer perimeter of a hinged at least partially cylindrical element on the undercarriage and is connected next to a carriage on the floating part, causing the spring load of the at least one spring element to supply a balancing momentum to rods of a hinged parallelogram-shaped four-rod system.

18. Seating unit according to claim 17, wherein the magnitude of a vertical constant force supplied by the spring compensation mechanism is adjustable by changing the vertical position of the carriage with respect to the floating part.

19. Seating unit according to claim 17, wherein the vertical distance between two points of contact of the flexible element 59 with the outer perimeters of the at least partially cylindrical element and the carriage, multiplied by the spring constant of the spring elements, equals the magnitude of a constant force delivered by the spring compensation system.

20. Seating unit according to claim 17, wherein the carriage is at least partially cylindrical, and wherein the total part of the flexible element with substantially constant length which is adjacent to the outer perimeter of the hinged cylindrical element on the undercarriage and the outer perimeter of the partially cylindrical carriage, remains constant during all movements of the carriage with respect to the undercarriage.

21. Seating unit according to claim 20, wherein the distance between the point of contact of the flexible element on the outer perimeter of the hinged at least partially cylindrical element on the undercarriage, and the point of contact of the flexible element on the outer perimeter of the partially cylindrical carriage, is substantially equal to the extension of the spring elements from a relaxed state, during all movements of the carriage in relation to the undercarriage.

22. Seating unit according to claim 17, wherein the flexible element with substantially constant length is constructed from a thin band of material with little flexibility along its length, which is in particular banded steel with a thickness of less than 0.2 millimetres.

23. Seating unit according to claim 17, wherein the friction in the spring compensation mechanism is such that an additional force of a maximum of 25N, in particular a maximum of 10N, is needed to set the floating part in motion in the movement range.
